(19) United States
(12) Patent Application Publication
(10) Pub. No.: US 2015/0345526 A1
(43) Pub. Date: Dec. 3, 2015

(54) Attachment Arrangement

(71) Applicants: TALENT PLASTICS AB, Herrljunga (SE); SWEDFAST AB, Torup (SE)

(72) Inventor: Pal SKJETNE, Ljungbyhed (SE)

(21) Appl. No.: 14/649,624

(22) PCT Filed: Dec. 6, 2013
(86) PCT No.: PCT/SE2013/051462

§ 371 Date: Jun. 4, 2015

(30) Foreign Application Priority Data
Dec. 6, 2012 (SE) 1251383-4

(51) Int. Cl. F16B 5/02

(52) U.S. Cl. CPC F16B 5/02

(57) ABSTRACT

An attachment arrangement comprising a plate part (4) for recess into a shelf (9), and a sidewall part (1) for the attachment in a sidewall (8), wherein said plate part (4) has predetermined outer edge shapes (47, 49) comprising: a cylindrical outer edge portion (47); a flat front edge portion (49) intended to be aligned with the outer edge (91) of the shelf (9); and an inner recess (42) with a rear support surface (44) arranged in a plane which is at least essentially parallel to said flat front edge portion (49); and wherein said sidewall part (1) has a securing portion (10) with threads (100, 101) and an engagement portion (2, 7) for engagement in the plate part (4), which engagement portion (2, 7) has a rear end with a surface (22, 79) intended to abut against said rear support surface (44), and a front end (23, 73) facing the securing portion (10), which front end has a press surface (23, 73) intended to be pressed against a side (80) of the sidewall (8), wherein said recess (42) comprises a slot-shaped groove (50) ending downwards into said flat front edge portion (49) as well as front support surfaces (43A, 43B) for the engagement portion (2, 7).

### TECHNICAL FIELD

The present invention relates to an attachment arrangement comprising a plate part for recess into a plate or the like, preferably in a piece of furniture, an interaction sidewall part for the attachment in a sidewall or a partition or the like, wherein said plate part has predetermined outer edge shapes comprising:
a cylindrical outer edge portion intended for clamp fit inside a boring in the plate;
a flat front edge portion intended to be arranged flush with the outer edge of the plate and preferably in abutment against one side of the sidewall; and
an inner recess with a rear support surface which is situated in a plane which is parallel to, or at least essentially parallel to said flat front edge portion, and wherein said sidewall part has an securing portion provided with threads for the securing in the sidewall, and an engagement portion for engagement in the plate part;
   which engagement portion has a rear end with a surface which is intended to abut against said rear support surface and a front end with a press surface facing the engagement portion, which end is intended to be pressed against said side of the sidewall.

### PRIOR ART

Such an attachment arrangement is known through U.S. Pat. No. 4,545,698 (Koch), which, however, has the drawback that it gives insufficient strength and precision, especially concerning lightweight pieces of furniture, where a thin outer veneer is used in combination with a lightweight core, e.g. made of cardboard.

A similar attachment arrangement with similar disadvantages is also known through U.S. Pat. No. 4,353,663 (Glickman), where the sidewall part is a plastic plug with grip teeth instead of threads.

Further, another similar attachment arrangement is known through US2012/0125873, which shows the disadvantages that the plate part is arranged with a certain play, which may give a detrimental moment inwards towards the plate. Further, the assemblage of the arrangement has to take place by means of a lateral displacement, which requires a space which is not always available. In addition, the locking downwards is unsatisfactory.

There is a demand for a better attachment arrangement, which above all provides sufficient strength and precision to be used satisfactorily in lightweight materials.

### BRIEF DESCRIPTION OF THE INVENTION

The object of the present invention is to provide an attachment arrangement which eliminates, or at least minimizes, the above mentioned problems, which is achieved in accordance with the definitions in the patent claims.

Thanks to the attachment arrangement of the invention a surprisingly good strength and precision is achieved also at the use of lightweight materials, which implies essential cost and environmental advantages. Further, the invention admits an attachment arrangement which, thanks to a good strength and a simple handling, quickly and comfortably enables attachment of a plate, e.g. in the form of a shelf, or any other horizontal support surface, or in the form of a vertical support part, e.g. a base. Of course, its functionality may be of advantage also in other connections.

The slot-shaped groove has preferably an upper, somewhat narrower, resilient portion arranged to admit clamp fit of said engagement portion in an assembled position, which i.a. provides the advantage that the attachment may be used in great variety of applications, as it may be uniting without help of the gravity.

Said arrangement is preferably also constructed as modules and comprises a combination of different connectable parts, wherein the attachment arrangement suitably comprises at least two plate parts with different inner configurations, wherein a first configuration is intended directly to receive an engagement portion in the form of a screw head in said sidewall part, and a second configuration is intended to receive an engagement portion in the form of an adapter device integrated in the sidewall part.

It is suitable that said securing portion is available in a plurality of different shapes/combinations, comprising an securing portion in the form of a screw shaft with a M-thread, intended to interact with a screw sleeve, and a securing portion in the form of a screw shaft with a screw thread intended to be able to fasten well in different kinds of sidewalls, but above all to fasten well in composite sidewalls of a lightweight type, for instance so called lightweight plates with a paper core, which on both sides is covered by a thin, hard plate containing wood fibres.

### BRIEF DESCRIPTION OF THE DRAWINGS ENCLOSED

Below the invention will be described further with reference to preferred embodiments and the drawings enclosed, wherein a piece of furniture comprising a shelf is used as a non-limiting example.

FIG. 1 is a sideview of a first preferred embodiment of an attachment arrangement according to the invention at the attachment of a shelf or the like to a sidewall or another vertical wall of a piece of furniture, which attachment arrangement comprises a plate part for recess into a shelf and an interacting sidewall part for the attachment in the sidewall, where the parts are separated.

FIG. 2 is a view from below of the attachment arrangement of FIG. 1 with the plate part and the sidewall part separated.

FIG. 3 is a cross-sectional view through two separated sidewall walls of a composite type with a paper core, of which each one is provided with a sidewall part according to FIGS. 1 and 2, and an intermediate shelf, which at its ends is provided with a plate part according to FIGS. 1 and 2.

FIG. 4 is a view from below of the arrangement of FIG. 3.

FIG. 5 is a side view of an assembled attachment arrangement according to FIGS. 1 through 4.

FIG. 6 is a view from below of an alternative embodiment included in a module system according to a preferred concept of the invention, wherein the plate part and the sidewall part are shown separated before the junction thereof.

FIG. 7 is a view from below of an additional embodiment of a module-based attachment arrangement, wherein a sidewall part with a M-thread is used.

FIG. 8 is a cross sectional view through a partition, which on both sides carries the attachment arrangement of FIG. 7, joined by a threaded sleeve.

FIG. 9 shows an alternative attachment arrangement according to the invention, where a rivet with an inner M-thread is fixed in a surface plate for interaction with a securing portion with a M-thread.

### DETAILED DESCRIPTION OF PREFERRED EMBODIMENTS

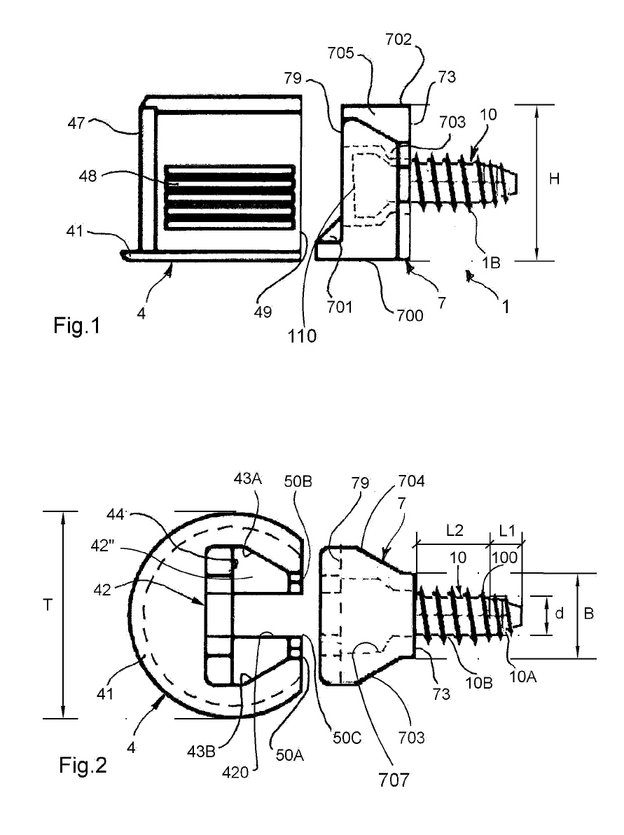

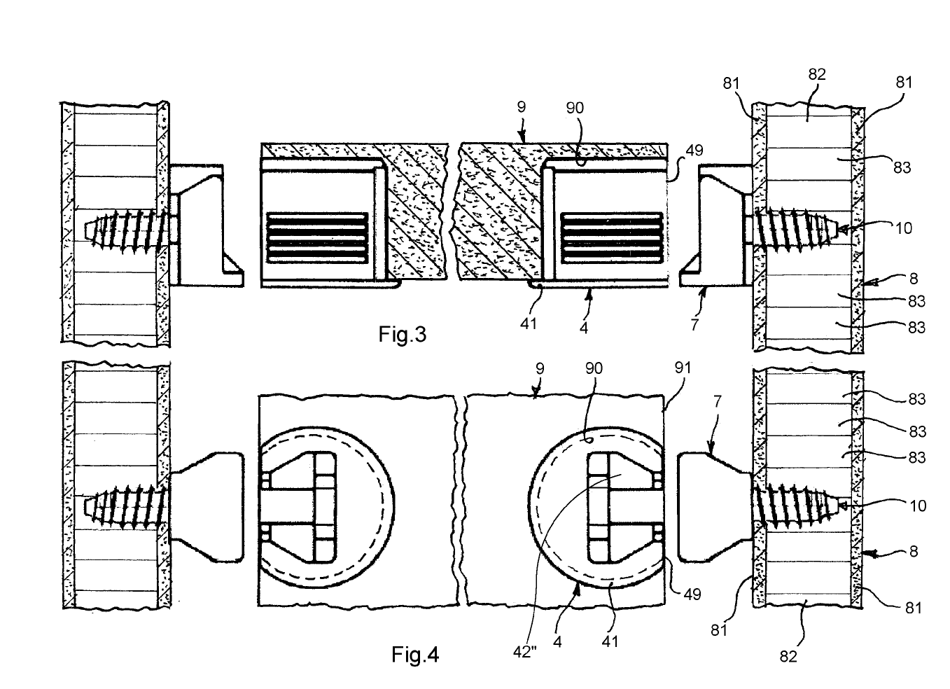

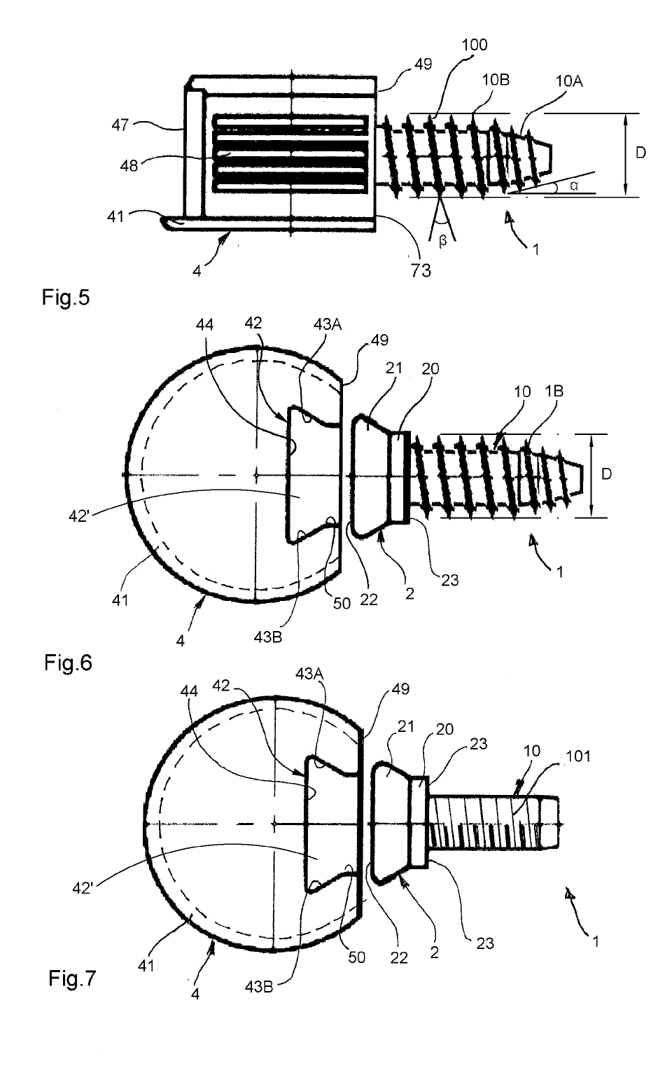

FIGS. 1 and 2 show views of a first preferred embodiment of an attachment arrangement according to the invention, here in an example for the attachment of a shelf 9 or any similar horizontal plane in a piece of furniture against a sidewall 8 or a partition or any similar vertical wall of a piece of furniture. The attachment arrangement comprises a plate part 4 for recess in a shelf 9 (FIGS. 3 and 4) and an interacting sidewall part 1 for the attachment in the sidewall 8. The expression “sidewall” means in this context any vertical wall, against which the shelf can be attached, thus also vertical partitions in the piece of furniture. While the FIGS. 1-4 show the plate part 4 and the sidewall part 1 separated from each other, FIG. 5 shows the parts 1, 4 joined together.

The plate part 4 has predetermined outer edge shapes 47, 49 comprising:
a cylindrical outer edge portion 47 intended for clamp fit inside a boring 90 in the shelf 9 (FIGS. 3 and 4);
a flat front edge portion 49 intended to be aligned with the outer edge 91 of the shelf 9 (FIGS. 3 and 4) and preferably in abutment against one side 81 of the sidewall 8 (FIGS. 3 and 4); and
an inner recess 42 with a rear support surface 44 situated in a plane parallel to said flat front edge portion 49.

The sidewall part 1 comprises a front securing portion 10 provided with threads 100, and a rear engagement portion 7, adapted to the recess 42 in the plate part 4 (see FIG. 2).

According to the invention, the recess 42 comprises a slot-shaped groove 50A, 50B, 50C arranged in the front edge portion 49 and ending downwards. Between the rear support surface 44 of the recess 42 and the slot-shaped groove 50A-C there are front support surfaces 43A, 43B for the engagement portion 7. The slot-shaped groove 50A-C has an inner limit edge, which along its entire extension is preferably arranged at an essentially constant distance from the rear support surface 44.

To keep the plate part 4 in the boring 90 in the shelf 9, it is suitable that a plurality of arc-shaped securing ridges 48 are arranged on at least two diametrically opposite regions of the cylindrical outer edge portion 47 of the plate part 4. In the embodiment shown in the figures there are five such parallel securing ridges 48 at each of the two opposite sides, but, of course, more or fewer ridges may be used, if desired. Further, the cylindrical outer edge portion 47 of the plate part 4 has a lower, protruding flange 41, which for strength reasons and appearance reasons covers the edge of the boring 90.

According to a preferred embodiment of a piece of furniture according to the invention, a lightweight material is used comprising a lightweight core 82 covered by surface plates 81, e.g. veneer sheets, metal sheets or wood fibre based laminates. The lightweight core 82 may suitably consist of a paper core 82 with cavities 83 extending transversely, e.g. throughout between the two covering plates 81. The cavities 83 may be shaped in many different ways, e.g. with a rounded cross-section as in corrugated cardboard or an angular cross-section, e.g. hexagonal. The thin, hard surface plate 81 covering the composite sidewall 8 runs the risk to be exposed to such heavy loads that breakages in the thin, hard covering plate 81 may arise if current attachment arrangements are used. Therefore, it is suitable, as is shown in FIGS. 1, 2, 3, and 4, to use a sidewall part 1 comprising an engagement part i the form of an adapter 7, wherein the plate part 4 is designed to receive the adapter 7. In this embodiment, the engagement portion 7 and the securing portion 10 are two separate, but interacting components in the form of a so called adapter 7 and a screw 10, respectively.

The adapter 7 consists in principle of a hexagonal block with a front forming a press surface 73 for abutment against the sidewall 80, and a rear side 79 parallel to the front 73 for abutment against the rear support surface 44 in the plate part 4. The front 73 is shaped to fit into the slot-shaped groove 50A-C. If desired, the edges of the groove and the edges of the front may have the shape of sloping saw teeth with a few teeth, and the front 73 may be narrower at the top than at the bottom to make it easier for the adapter 7 to enter the recess 42 in the plate part 4. The rear side 79 is considerably wider than the front 73 and may be approximately twice as wide. The block has a through hole 707 for the screw 10, which hole 707 extends perpendicularly towards the front and the rear side. The hole 707 is suitably shaped such that the screw head will be countersunk in the adapter 7. At tightening of the screw 110, the front 73 of the adapter 7 will be pressed towards the sidewall side 80. In this embodiment, you can, if you so desire, use a screw 110, which is provided with either a conic head portion or a flat head portion.

An advantage is, however, that the front 73 forms a comparatively large press surface which contributes to a good strength also in thin veneer layers 81. Because of the design of the adapter 7 a large front surface 73 is easily obtained as its entire height H can be used which implies that the width B can be essentially smaller, e.g. B<H<2B.

FIGS. 2 and 5 show more in detail the securing portion 10, which is preferably used in connection with lightweight constructions having a comparatively thin surface plate 81. The securing portion 10 has a special design in order to give a sufficient strength and precision. In the preferred case, a very good strength can be obtained also in very thin surface layers 81, thanks to the attachment arrangement and a securing portion 10 according to the invention. The thinner surface layer 91 which can be used, the more cost efficient and more harmless to the environment a piece of furniture can be manufactured. The securing portion 10 according to the invention fastens well in the surface layer 81, which is thinner than 5 mm. In a more preferred embodiment according to the invention, a surface layer 81 is used having a thickness of max 4 mm, in the preferred case a thickness above 2 mm and below 4 mm. The thread shaft of the screw is provided with threads 100 with a thread pitch of between 1.6 and 2.0 mm. The angle 13 of the thread top is in the range of 55° to 65°. The screw shaft has a rear portion 10B with an essentially constant outer diameter and inner diameter, respectively, wherein the outer diameter D suitable is in the region of 6 to 6.5 mm and the inner diameter d suitably is in the region of 4.7 to 5.1 mm. The front portion 10A of the screw shaft is conically shaped with a point angle in the region of 25° to 40°, preferably 30° to 40°. The length L1 of the front portion 10A suitably is less than the length L2 of the rear portion 10B. According to a preferred embodiment, the length L1+L2 of the screw shaft is in the region 10 mm+2 mm, more preferred 10 mm+1 mm. The front portion 10A preferably ends with a flat circular portion with a point diameter in the region of 2.5 to 3.5 mm, more preferred 3.0 to 3.4 mm. According to the most preferred embodiment, the screw head 110 is provided with a so called “ttap”-grip, implying that the screw together with the adapter can be kept fixed on the screw means (not shown) in connection with the assembling, which implies essential facilitation at the assembling.

Of course, the screw head can also be provided with a conventional recess (not shown), e.g. a Pozidriv cross recess or any other known recess to enable that you with an optional conventional tool will be able to turn the screw at the assembling of the sidewall part 1.

FIG. 2 shows that two essentially vertical block sides 703, 704 extend between the front 73 and the rear side 79 as well as the upper side 702 and the bottom side 700 of the adapter, which block sides are adapted to abut against the front support surfaces 43A and 43B in the recess 42 in the plate part 4. Right at the top these vertical block sides may be rounded in a direction inwards towards the top side 702 of the block. The top side suitably comprises an upwards protruding projection 705, e.g. in the form of a low parallelepiped fitting into a corresponding recess 420 in the upper side of the plate part 4, as will described more in detail below.

To achieve a stable securing of the adapter 7 in the plate part 4, the bottom side 700 of the block is suitably elongated a short distance backwards. Two triangular reinforcements 701 are arranged at a distance from each other in the angle formed between the rear side 79 and the backwards protruding elongation. These reinforcements also contribute to guide the adapter to the desired final position in the plate part 4.

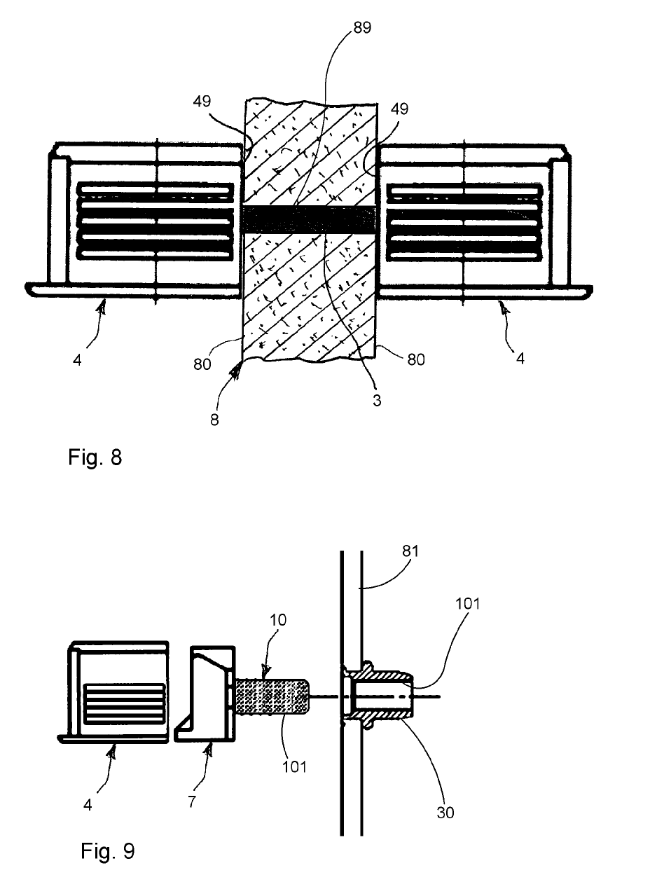

In its simplest construction, the sidewall part 1 consists of a screw with a securing portion 10 in accordance with the above description, as is shown in FIGS. 6 and 7, i.e. a screw shaft provided with threads 100, 101 and an engagement portion 2 in the form of a screw head. The sidewall part 1 also has an securing portion 10 in the form of a screw shaft for the securing in the sidewall 8 as well as a screw head 2 for the engagement in the plate part 4. The engagement portion 2 has a rear end with a surface 22, which is intended to abut against the rear support surface 44 of the plate part, and a front press surface 23 which is intended to abut against the side 80 of the sidewall 8. The screw head 2 suitably is of the design generally called countersunk and also has a substantially conic, towards the screw shaft tapering shape. The end surface 22 and the rear support surface 44 have shapes adapted to each other and they suitably are flat. At the passage between the conic portion 21 of the head and the screw shaft the head has a cylindrical portion 20 ending with the press surface 23, which is intended to abut against said side 80 of the sidewall 8. The bottom side of the screw head is thus formed by the annular press surface 23 and the surface of the conic portion 21 of the head.

In the embodiment shown in FIGS. 6 and 7, the width of the slot-shaped groove 50A-C is adapted to the diameter of the cylindrical portion 20 of the head, so that the portion 20 can easily enter into the lower portion 50A of the groove to then be forced past a narrower, middle portion 50B of the groove, which portion is somewhat resilient, and then snap into an end position where the groove in its upper portion 50C again gets wider. The front support surface 43A, 43B of the inner recess 42 in the plate part 4 are adapted to the conic surface 24 of the conic portion 21 of the screw head, so that the screw head, when it is in its end position 50C in the upper portion of the groove, is kept without any play by the support surfaces 43A 43B and 44 in the recess 42. If desired, the distance between the front support surfaces 43A, 43B can be larger at the lower portion 50A of the groove than at its upper portion 50C, so that the front support surfaces 43A, 43B converge towards each other in an upward direction, whereby the screw head 2 easily enters into the lower portion 50A of the groove but still can be kept without any play in the upper portion 50C of the groove.

As is shown in FIG. 7, the screw threading of the securing portion 10 can also consist of a M-thread 101, intended to interact with a screw sleeve or a rivet 30.

As the adapter 7 takes a larger space in the plate part 4 than the pure screw head 2 does, the support walls 44 of the recess 42 will need to be further back at the use of the adapter. While the rear support surface 44 according to the first embodiment of the plate part 4 is at a distance of ⅛×T in front of the centre of the plate part 4, where T is the diameter of the plate part, the rear support surface 44 according to the second embodiment of the plate part 4 is approximately at the mid of said centre. This implies that the front support surfaces 43A and 43B then get somewhat larger. Further, the upper end of the slot-shaped groove suitably is the end for the screw head 2, while it for the adapter suitably is not closed and continues up through an opening 420 in the upper side of the plate part 4, where the edges of the opening 420 formed are guides for the low parallelepipedic recess 705 in the upper portion of the adapter 7. In addition, there are recesses in the bottom side 4 of the plate part which are adapted to receive the rearwards protruding elongation of the adapter 7 and the two triangular reinforcements during the guidance of the adapter 7 and the plate part 4 relative each other. In both embodiments, the plate part 4 further has, behind the wall forming the rear support surface 44, two from above downwards running identical recesses which are separated by a transition wall and radially limited outwards by a wall forming the cylindrical outer edge portion 47 of the plate part 4. These recesses diminish the consumption of material at the manufacture of the plate part 4. Further, the upper ends of the front support surfaces 43A and 43B suitably have a rounding in the direction inwards towards the groove portion 50C in the upper side of the plate part 4, which rounding corresponds to the rounding of the two essentially vertical block sides on the adapter 7, which are adapted to abut against the front support surfaces 43A and 43B. The adapter 7 has such a size that it, when the plate part 4 is recessed over it to the final position, it is accommodated in the plate part 4 with its front surface 73 in level with the front surface 49 of the plate part. The press surface 73 of the adapter is comparatively large, which is preferably achieved by making its height H essentially larger than its width B.

FIG. 8 shows two attachment arrangements, where de securing portions/screw heads 10 protruding from the plate parts 4 have M-threads which are fixed in a common screw sleeve 3. According to this example, the sidewall is e.g. a fibre board with the same material in its surface layer 80 as in the inner of the plate. A common sidewall 8 is used by arranging a screw sleeve through a bore 89 in the sidewall, which implies an essential material saving as compared with conventional pieces of furniture where normally double sidewalls 8 are used.

FIG. 9 shows an alternative attachment arrangement according to the invention, where a rivet 30 with an inner M-thread 101 is fixed in a surface plate 81 for interaction with a securing portion 10 with a M-thread 101 for the attachment of a sidewall part with an adapter 7.

The man skilled in the art realizes that an attachment arrangement according to the invention is not limited by what is described above but that its application can gain advantages in many different types of constructions and materials, and material combinations, respectively, as well as that the use of the expression a piece of furniture shall be given an interpretation also comprising stationary arrangements, e.g. kitchen fixtures and the like. Concerning lightweight materials, reference can especially be made to advantages at the use of conic filler elements/cavity structures according to SE 533787. Further, it is realized that such filler elements can be manufactured in a plenty of varying ways, e.g. of a vacuum moulded cellulose pulp which can be reinforced with polylactic acid (PLA), moulded wood substitutes, composites, aluminium, plastic, or steel. In the same manner, it is true that the surface plates 81 may be manufactured in a number of embodiments, e.g. made of any of the materials wood, wood substitute, composite, paper, aluminium, plastic, or steel, or of combinations thereof.

1. An attachment arrangement comprising a plate part (4) for recess into a plate (9) or the like, preferably in a piece of furniture, and an interacting sidewall part (1) for the attachment in a sidewall (8) or a partition or the like,
wherein said plate part (4) has predetermined outer edge shapes (47, 49) comprising:
a cylindrical outer edge portion (47) intended for clamp fit inside a boring (90) in the plate (9);
a front edge portion (49); and
an inner recess (42) with a rear support surface (44) which is situated in a plane which is parallel to, or at least essentially parallel to said flat front edge portion (49), and wherein said sidewall part (1) has an securing portion (10) provided with threads for the securing in the sidewall (8), and an engagement portion (2, 7) for engagement in the plate part (4);
wherein said sidewall part (1) has a securing portion (10) with threads (100, 101) for the securing in the sidewall (8) and a engagement portion (2, 7) for engagement in the plate part (4), which engagement portion (2, 7) has a rear end with a surface (22, 79) intended to abut against said rear support surface (44), and a front end (23, 73) facing the securing portion (10);
wherein said recess (42) comprises a slot-shaped groove (50) ending downwards in said flat front edge portion (49), as well as front support surfaces (43A, 43B) for the engagement portion (2, 7), which surfaces extend essentially parallel to the front edge portion (49) between the rear support surface (44) and the slot-shaped groove (50), and wherein said securing portion (10) comprises a rear portion (10B) with a thread (100) with an essentially constant outer thread diameter (D), and a front portion (10B) with a conic thread,
characterized in that said front edge portion (49) consists of a flat surface arranged to be aligned with the outer edge (91 of the plate (9) and preferably in abutment against one side (80) of the sidewall (8) or the partition, and that said engagement portion (2, 7) has a front end with a press surface (23, 73) arranged to be pressed against said side (80) of the sidewall (8) or the partition.

2. An attachment arrangement according to claim 1, characterized in that the slot-shaped groove (50) has a lower, wider portion (50A) and a narrower, resilient portion (50B) arranged above said lower portion in order to admit a clamp fit with said engagement portion (2, 7) in a secured position.

3. An attachment arrangement according to claim 1, characterized in that a proportion between a length (L2) of said rear portion (10B) and a length (L1) of said front portion (10A) is such that L1≦L2, more preferred that 1<L2/L1<3.

4. An attachment arrangement according to claim 1, characterized in that a cone angle (α) of said front portion (10A) is in a region of 25°<α<40°, preferably 30°<α<35°.

5. An attachment arrangement according to claim 1, characterized in that a thread top angle (β) of said thread (100) is such that 55°≦β≦65°, and preferably that a thread pitch is between 1.5 and 2 mm, preferably 1.8 mm±0.1.

6. An attachment arrangement according to claim 1, characterized in that the outer diameter (D1) of said rear portion (10B) is between 6.1 and 6.5 mm, and its inner diameter (d) is between 4.7 and 5.1 mm, preferably 6.3 mm±0.1, and 4.9 mm±0.1, respectively.

7. An attachment arrangement according to claim 1, characterized in that said engagement portion is in the form of an adapter device (8) integrated in a sidewall part (1), wherein said press surface (73) has an extension in a vertical direction (H) which is larger than a width (B) of said press surface.

8. An attachment arrangement according to claim 7, characterized in that said plate part (4) is present in at least two constructions with different inner configurations of said recess (42, 42′, 42″), wherein a first configuration (42′) is intended directly to receive an engagement portion in the form of a screw head (2) in said sidewall part (1), and a second configuration (42″) is intended to receive an engagement portion in the form of an adapter device (7) integrated in the sidewall part (1).

9. An assembled piece of furniture, comprising at least a plate (9) and a sidewall (8), joined through an attachment arrangement (1, 4) comprising a plate part (4) for recess into said plate (9) and an interacting sidewall part (1) for the attachment in a sidewall (8) or a partition or any similar vertical wall of the piece of furniture,
wherein said plate part (4) has predetermined outer edge shapes (47, 49) comprising:
a cylindrical outer edge portion (47) which with clamp fit is in engagement inside a boring (90) in the plate (9);
a flat front edge portion (49) aligned with the outer edge (91) of the plate (9) and preferably in abutment against one side (80) of the sidewall (8); and
an inner recess (42) with a rear support surface (44) arranged in a plane which is parallel to, or at least essentially parallel to, said flat front edge portion (49); and
wherein said sidewall part (1) has a securing portion (10) provided with threads (100) for the securing in the sidewall (8) as well as an engagement portion (7) for engagement in the plate part (4), which engagement portion (7) has a rear end with a surface (79) which is intended to abut against said rear support surface (44), and a front end facing towards the securing portion (10) with a press surface (73) intended to be pressed against said side (80) of the sidewall (8); wherein said recess (42) comprises a slot-shaped groove (50) ending downwards in said flat front edge portion (49), as well as front support surfaces (43A, 43B) for the engagement portion (2, 7), which support surfaces extend essentially parallel to the front edge portion (49) between the rear support surface (44) and the slot-shaped groove (50), wherein said securing portion (10) comprises a rear portion (10B) with an essentially constant outer thread diameter (D), as well as a front portion (10B) with a conic thread, and wherein said sidewall (8) is a lightweight sidewall of a composite type having a lightweight core (82) which at least on one side is covered by a thin, hard plate (81), preferably containing wood fibres, with a thickness (t) in the region of 2 mm≦t≦4 mm, preferably 3<t<4 mm, which plate (81) is in engagement with the threads (100) in the rear portion (10B) of said securing portion (10).

10. An assembled piece of furniture according to claim 9, characterized in that said engagement portion is in the form of an adapter device (7) included in the sidewall part (1), wherein said press surface (73) has an extension in a vertical direction (H) which is larger than a width (B) of said press surface.

11. An assembled piece of furniture according to claim 9, characterized in that the slot-shaped groove (50) preferably has a lower, wider portion (50A) and a narrower, resilient portion (50B) arranged above said lower portion in order to admit a clamp fit with said engagement portion (2, 7) in a secured position.

12. An assembled piece of furniture according to claim 9, characterized in that said securing portion (10) is available in a plurality of designs, also comprising a securing portion (10) in the form of a screw head with a M-thread (101) interacting with a screw sleeve (3).

13. An assembled piece of furniture according to claim 12, characterized in that said piece of furniture contains a sidewall (8) with shelves (9) arranged in direct connection at both sides of the sidewall (8).
